(19) United States
(12) Patent Application Publication
(10) Pub. No.: US 2011/0278198 A1
(43) Pub. Date: Nov. 17, 2011

(54) EDGE PROTECTOR WITH TRANSVERSE WEAKNESS FOR EASY SEPARATION OF PROTECTOR WHEN ONE STACK IS LIFTED FROM ANOTHER

(75) Inventor: Jeffrey Paul Hazell, Temecula, CA (US)

(73) Assignee: Sony Corporation

(21) Appl. No.: 12/822,500

(22) Filed: Jun. 24, 2010

Related U.S. Application Data
(60) Provisional application No. 61/334,237, filed on May 13, 2010.
(60) Provisional application No. 61/346,204, filed on May 19, 2010.

(51) Int. Cl. B65D 81/02; B26D 7/00; B65D 21/032

(52) U.S. Cl. 206/586; 220/23.83; 53/396

(57) ABSTRACT

CE device containers are stacked into multiple rows, and the edge of each corner of the stack is covered by a single edge protector. The edge protectors are transversely weakened at locations corresponding to each row interface, so that at a shipping destination a row of containers can be lifted off of the row underneath, breaking the edge protectors at the weakened locations without requiring manual removal of the entire edge protector prior to unstacking.

This application claims priority from U.S. provisional patent application Nos. 61/334,237, filed May 13, 2010 and 61/346,204 filed May 19, 2010, both of which are incorporated herein by reference.

### I. FIELD OF THE INVENTION

The present application relates generally to edge protectors for stacks of containers that separate transversely into segments when one stack is lifted from a lower stack.

### II. BACKGROUND OF THE INVENTION

Consumer electronics (CE) devices such as TVs are typically shipped from the factory in containers. The containers usually are cardboard boxes, and the boxes ordinarily are stacked on each other in pallet-sized stacks for more efficient movement of many boxes using clamp trucks and the like.

As understood herein, during transit, owing to shifting and other factors, edges of the boxes may collide with other boxes, objects in the conveying vehicle, etc. and so can become damaged. While the product inside a damaged box may survive unscathed owing to foam packing, the recipient of the box (e.g., a retail outlet) cannot know for sure the condition of the product inside a damaged box. Present principles thus recognize that a damaged box may simply be returned by the recipient to the manufacturer, cascading return costs.

As further recognized herein, protecting the edges of boxes with additional structure can be problematic. Either the edge of each individual box must be protected prior to stacking, which increases production time and labor costs, or, to save labor, the edge of an entire stack of boxes may be protected. This latter approach, however, as understood by present principles, entails complications at the receiving end, because prior to box unstacking the edge protectors must be manually removed, compared to the relative ease and efficiency of simply unstacking boxes using a clamp truck (or other machine such as a forklift) without requiring intervening manual steps.

### SUMMARY OF THE INVENTION

Accordingly, an assembly includes plural containers of substantially identical configuration arranged in a stack of at least first and second rows of containers defining a row junction therebetween. The first row is disposed on top of the second row. Each container defines a height “H”, and the stack defines an overall height “OL” that is equal to N*H, wherein N is the number of rows of containers in the stack. Also, the stack defines plural vertical edges of length “OL”. An elongated edge protector covers substantially an entire vertical edge of the stack and has a length substantially equal to “OL”. The edge protector includes first and second elongated flanges joined together along a respective flange sides to establish a joint. The flanges are oriented at a right angle to each other, with the joint being disposed over the vertical edge of the stack. The edge protector is further formed with at least one transversely weak region perpendicular to a long axis of the edge protector. With more specificity, a transversely weak region is formed on the edge protector at intervals of “H” along the long axis such that a transversely weak region of the edge protector is substantially co-planar with each row junction. With this arrangement, at a shipping destination when a row of containers is lifted off of the row underneath, the lifting causes the edge protector to be automatically broken at the transversely weak region located at the associated row junction without requiring manual removal of the entire edge protector prior to unstacking.

If desired, a respective edge protector can cover each of four vertical edges of the stack. In some example implementations the edge protector is formed of cardboard and the transversely weak region may be established by a line of circular perforations, a V-shaped score line, or a line of slit-like perforations.

In another aspect, a method includes stacking consumer electronic (CE) device containers into multiple rows to establish a container stack having row interfaces between rows. Each vertical edge of the stack is covered by a respective single unitary edge protector. The edge protectors are transversely weakened at regions corresponding to each row interface, so that at a shipping destination a row of containers can be lifted off of the row underneath, breaking the edge protectors at the weakened locations without requiring manual removal of the entire edge protector prior to unstacking.

In another aspect, an edge protector includes an elongated unitary body defining first and second ends, an elongated edge extending from one end to the other end, and first and second flanges extending away from the edge perpendicular to each other. “N” transversely weak regions are formed along the body to divide the body into N+1 segments of equal length to each other, wherein “N” is a positive integer at least equal to one.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view showing a stack of containers, with the right-most two edges of the stack having edge protectors disposed thereon and showing two other edge protectors in an exploded relationship with the left-most stack edges;

FIGS. 2-4 are side views of alternate examples of the edge protector, showing alternate structures for transversely weakening the edge protector, with portions cut away for clarity;

FIG. 4A is a cross-sectional view as seen along the line A-A in FIG. 4; and

FIG. 5 is a flow chart of example logic in accordance with present principles.

### DETAILED DESCRIPTION OF THE PREFERRED EMBODIMENT

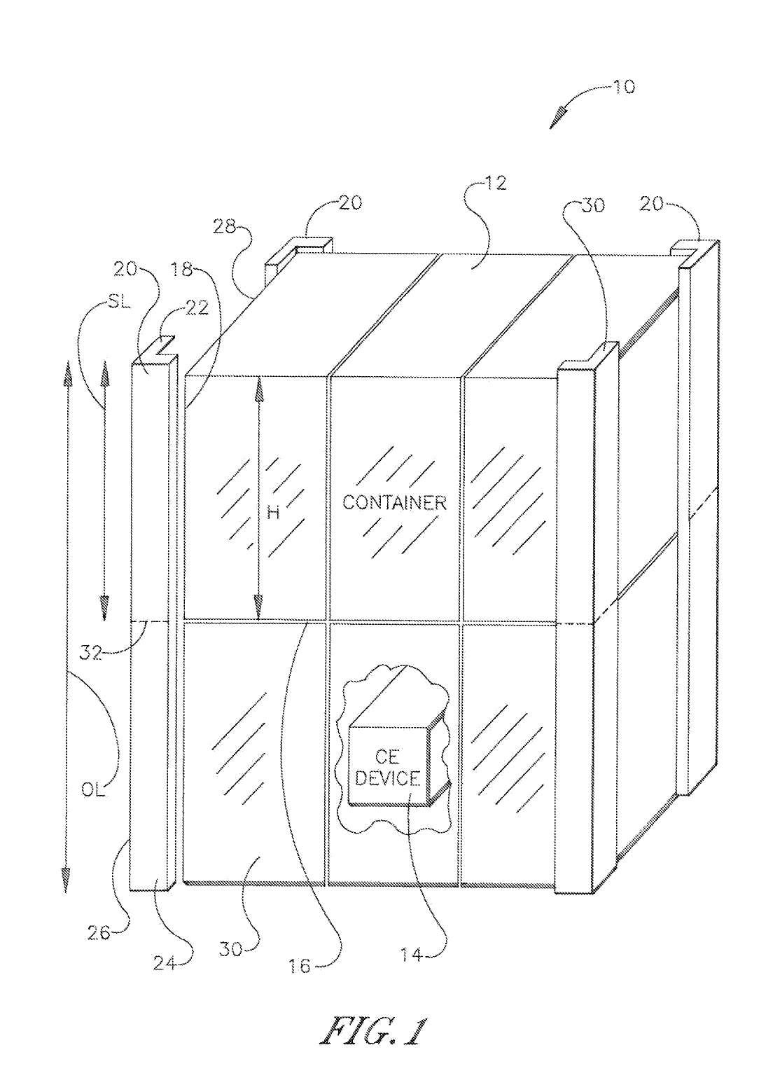

Referring initially to FIG. 1, a stack 10 of containers 12 such as cardboard boxes is shown. Each container 12 holds one or more consumer electronics (CE) devices 14 such as a TV, game player, video disk player, camera, digital cloak radio, mobile telephone, personal digital assistant, laptop computer, etc. While FIG. 1 shows that the stack 10 includes two rows of three containers each, it is to be understood that present principles apply to container stacks of greater than two rows each of which may have two or more containers. Also, while “rows” of containers are referred to since FIG. 1 for simplicity shows only a single line of containers 12 in each row, typically the stack 10 is composed of blocks or layers of containers, i.e., additional containers are typically located behind those shown in FIG. 1. It is to be understood that present principles envision covering the (typically) four exposed edge corners of the stack 10 regardless of how many containers deep a row happens to be, so for present purposes “row” means a layer of containers with rows that are only one container deep as well as a layer of containers with rows that are more than a single container deep.

In any case, typically the containers have substantially identical configurations, i.e., are the same size and shape as each other within manufacturing tolerances. A row junction 16 is defined between adjacent rows of containers as shown.

As shown in FIG. 1, each container 12 defines a height “H” with the stack 10 defining a an overall height “OL” equal to N*H, wherein N is the number of rows of containers 12 in the stack 10. Thus, the stack 10 also defines plural (typically four) vertical edges 18 also of length “OL”.

At least one and, as shown, preferably all of the exposed vertical edges 18 of the stack 10 are covered by a respective elongated edge protector 20. The edge protector 20 covers substantially the entire exposed vertical edge of the stack (i.e., covers the entire edge from end to end of the edge with any uncovered end portions being de minimis relative to rejectable damage of the affected container). Thus, each edge protector 20 has a length substantially equal to “OL”.

Each edge protector includes first, and second elongated flanges 22, 24 joined together along a respective flange side 26 to establish a joint. The flanges 22, 24 are elongated and are oriented at a right angle to each other. As can be appreciated in reference to FIG. 1, when an edge protector is disposed against the stack 10 as intended, the joint 26 is disposed over the vertical edge 18 of the stack. One flange 22 lies substantially flush against one planar side 28 of the stack while the opposite flange 24 lies substantially flush against the adjacent planar side 30 of the stack.

According to present principles the edge protector 20 is further formed with at least one transversely weak region 32 that is oriented perpendicular to the long axis of the edge protector 20. The region 32 is a line of transverse weakness that is formed preferably in both flanges 22, 24, so that the line in the first flange 22 is coplanar with the line in the second flange 24.

As can be appreciated in reference to FIG. 1, the transversely weak region 32 is formed on the edge protector 20 at intervals of “H” along the long axis of the edge protector 20. Accordingly, a transversely weak region 32 of the edge protector is substantially co-planar with each row junction 16. While FIG. 1 shows only two rows of containers 12 in the stack 10, a stack may include more rows and so more generally “N” transversely weak regions 32 are formed along the body of the edge protector 20 to divide it into N+1 segments of equal length “SL” to each other, wherein “N” is a positive integer at least equal to one and wherein “SL” is substantially equal (within manufacturing tolerances) to the height “H” of a container 12. The edge protector 20 may be made of a unitary piece of cardboard or in some implementations plastic.

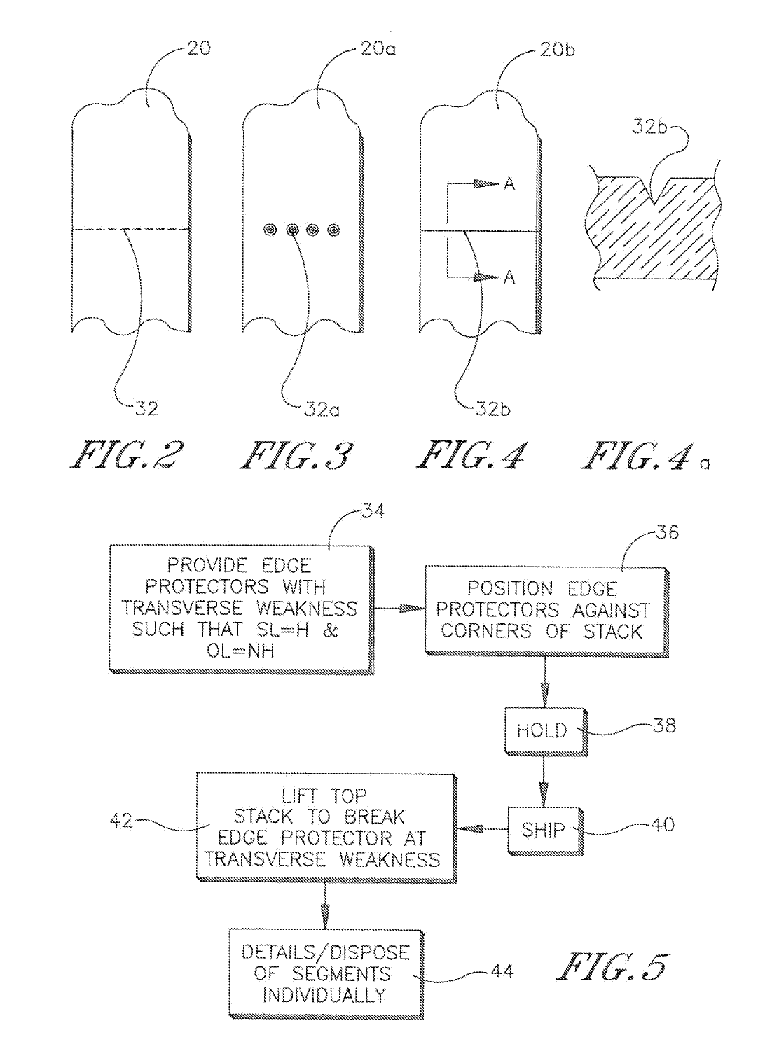

FIGS. 2-4 show example structures by which the transversely weak region 32 may be established. In FIG. 2, the region 32 is established by a line of slit-like perforations that are cut completely or part-way through the flanges 22, 24. FIG. 3, in contrast, shows that a transversely weak region 32a in an edge protector 20a may be established by a line of circular perforations cut through the flanges of the edge protector. Yet again, FIGS. 4 and 4A show that a transversely weak region 32b in an edge protector 20b may be established by a score line which, as shown in FIG. 4A, may be V-shaped in cross-section and which does not extend completely through the flanges of the protector 20b. In all other essential respects the edge protectors 20, 20a, and 20b shown in FIGS. 2-4 can be identical in configuration and composition to each other.

With the above disclosure in mind, attention is now drawn to FIG. 5. At block 34 the above-described edge protector(s) 20 are provided and then at block 36 positioned against respective edges (corners) of the stack 10. Block 38 indicates that the edge protectors are held against their respective edges (corners) by, e.g., stapling them to the containers in the stack and/or wrapping the stack in plastic sheet or other means.

Moving to block 40, the stack 10 with edge protectors 20 are shipped to a destination such as a retail outlet. Proceeding to block 42, the plastic wrapping, if any, is removed and the top, row of containers 12 is lifted from stack by, e.g., a forklift. The lifting action of the forklift automatically fractures the edge protectors 20 at the top-most transversely weak region 32, lifting the top-most segment of the edge protectors 20 away with the top-most row of containers and leaving the remainder of the edge protectors in place covering the exposed edges of the remaining containers in the stack. As each successive stack is lifted away the edge protectors are fractured along the highest surviving weak region 32 until only the bottom row of containers remains, the exposed edges of the containers covered by the bottom-most segment of the edge protectors 20. At block 44 the separated segments of the edge protectors 20 may be disposed of individually as the individual containers 12 in a layer of containers are separated from each other.

While the particular EDGE PROTECTOR WITH TRANSVERSE WEAKNESS FOR EASY SEPARATION OF PROTECTOR WHEN ONE STACK IS LIFTED FROM ANOTHER is herein shown and described in detail, it is to be understood that the subject matter which is encompassed by the present invention is limited only by the claims.

What is claimed is:

1. Assembly comprising:
plural containers of substantially identical configuration arranged in a stack comprising at least first and second rows of containers defining a row junction therebetween, the first row being disposed on top of the second row, each container defining a height “H”, the stack defining an overall height “OL” equal to N*H, wherein N is the number of rows of containers in the stack, the stack defining plural vertical edges of length “OL”; and
at least one elongated edge protector covering substantially an entire exposed vertical edge of the stack and having a length substantially equal to “OL”, the edge protector including first and second elongated flanges joined together along a respective flange side to establish a joint and oriented at a right angle to each other, the joint being disposed over the vertical edge of the stack, the edge protector being further formed with at least one transversely weak region perpendicular to a long axis of the edge protector, a transversely weak region being formed on the edge protector at intervals of “H” along the long axis such that a transversely weak region of the edge protector is substantially co-planar with each row junction.

2. The assembly of claim 1, wherein the stack defines four vertical edges, each being covered by a respective edge protector.

3. The assembly of claim 1, wherein the edge protector is formed of cardboard.

4. The assembly of claim 1, wherein the transversely weak region is established by a line of circular perforations.

5. The assembly of claim 1, wherein the transversely weak region is established by a score line.

6. The assembly of claim 5, wherein the score line has a V-shaped cross-section.

7. The assembly of claim 1, wherein the transversely weak region is established by a line of slit-shaped perforations.

8. Method comprising:
stacking consumer electronic (CE) device containers into multiple rows to establish a container stack having row interfaces between rows;
covering each vertical edge of the stack by a respective single unitary edge protector;
transversely weakening the edge protectors at regions corresponding to each row interface, so that at a shipping destination a row of containers can be lifted off of the row underneath, breaking the edge protectors at the weakened locations without requiring manual removal of the entire edge protector prior to unstacking.

9. The method of claim 8, wherein the edge protector is formed of cardboard.

10. The method of claim 8, wherein the regions are established by respective lines of circular perforations.

11. The method of claim 8, wherein the regions are established by respective score lines.

12. The method of claim 11, wherein the score lines have V-shaped cross-sections.

13. The method of claim 8, wherein the regions are established by respective lines of slit-shaped perforations.

14. Edge protector, comprising:
elongated unitary body defining first and second ends, an elongated edge extending from one end to the other end, and first and second flanges extending away from the edge perpendicular to each other; and
“N” transversely weak regions formed along the body to divide the body into N+1 segments of equal length to each other, wherein “N” is a positive integer at least equal to one.

15. The edge protector of claim 14, wherein the edge protector is disposed on a stack of containers, the length of each segment being equal the height of each container in the stack.

16. The edge protector of claim 14, wherein the edge protector is formed of cardboard.

17. The edge protector of claim 14, wherein at least one transversely weak region is established by a line of circles.

18. The edge protector of claim 14, wherein at least one transversely weak region is established by a score line.

19. The edge protector of claim 18, wherein the score lines have V-shaped cross-sections.

20. The edge protector of claim 14, wherein at least one transversely weak region is established by a line of slits.
